(19) United States
(12) Patent Application Publication
(10) Pub. No.: US 2010/0229315 A1
(43) Pub. Date: Sep. 16, 2010

(54) HANDLE FOR SURFACE CLEANING APPARATUS

(75) Inventor: Mark Rosenzweig, Chestnut Hill, MA (US)

Correspondence Address: LUCAS & MERCANTI, LLP, 475 PARK AVENUE SOUTH, 15TH FLOOR, NEW YORK, NY, 10016, US

(73) Assignee: Euro-Pro Operating LLC, West Newton, MA (US)

(21) Appl. No.: 12/402,837

(22) Filed: Mar. 12, 2009

(51) Int. Cl. B25G 1/00

(52) U.S. Cl. 15/144.1

(57) ABSTRACT

A handle for a surface cleaning apparatus comprises a lower handle portion, and an upper handle portion. A first pivoting lockable joint is provided between the lower handle portion and the upper handle portion. A second pivoting lockable joint is provided between the lower handle portion and the upper handle portion.

### FIELD OF THE INVENTION

The specification relates to handles for surface cleaning apparatus and surface cleaning apparatus, such as sweepers, vacuum cleaner, extractors and the like having same.

### INTRODUCTION

The following is not an admission that anything discussed below is prior art or part of the common general knowledge of persons skilled in the art.

United States patent application publication 2008/0155774 discloses a floor sweeping apparatus. It has a cleaning head and an elongate handle having a first portion fixed to the cleaning head at a pivoting joint, and at an outer end by a hinge to a second elongate handle portion. A locking mechanism allows the second portion to be locked in different angular positions relative to the first portion. The locking mechanism can be remotely controlled from the handle portion. Such designs have also been used in vacuum cleaners wherein air passes through an elongate bendable handle or wand. See for example U.S. Pat. No. 6,695,352 and U.S. Ser. No. 12/010,358.

### SUMMARY

The following introduction is provided to introduce the reader to the more detailed discussion to follow. The introduction is not intended to limit or define the claims.

According to an aspect of the invention, there is provided a handle for a surface cleaning apparatus constructed so as to bend, pivot or rotate to alter the configuration of the handle at two positions along the length of the handle. An advantage of this design is that the wand may be foldable in half, e.g., each joint pivoting 900. Preferably, the pivots are spaced a short distance apart, such as by a spacer or arm positioned between the two pivot joins. The spacer permits the handle to fold in half if the handle has members mounted to an external surface thereof, such as a power cord, an external lock control, a power switch or the like.

According to an aspect of the invention, a handle for a surface cleaning apparatus. It has a first, or lower, handle portion, and a second, or upper, handle portion. There is a first pivoting lockable joint provided between the lower handle portion and the upper handle portion. There is a second pivoting lockable joint between the lower handle portion and the upper handle portion.

According to another aspect, there is provided a handle for a surface cleaning apparatus. It has a first, or upper, handle portion at an upper region of the handle, and a second, or lower, handle portion at a lower region of the handle. There is a first pivoting lockable joint located at a mid-region of the handle. There is also a second pivoting lockable joint located at the mid-region of the handle.

According to another aspect, there is provided a handle for a surface cleaning apparatus. It has a lower handle portion and an upper handle portion. There is a first pivoting lockable joint that allows the lower handle portion and the upper handle portion to pivot with respect to each other. There is also a second pivoting lockable joint that allows the lower handle portion and the upper handle portion to pivot with respect to each other.

In some examples, a single actuator is provided to unlock each joint. Preferably, one of the joints, preferably the upper one, has two locks, namely a first that comprises lock that cannot be overcome by applying force to the lock without breaking to lock, and a second that can be released by the application of force without breaking the lock. The first may comprise a lock that is received in a rotatable member or that comprises first and second interlocking members provided on each side of a pivot joint. The second may be a friction or detent lock. An advantage of this design is that a user may operate an actuator to release the locks. The first lock may then rotate freely. If it is desired to further bend the handle, such as to put the surface cleaning apparatus in storage, the user may apply force at each distal opposed end of the handle to bend the handle in half without having to push any more buttons to release a lock.

In some example, the actuator or actuators are provided on an upper end of the hand and preferably adjacent a handgrip portion.

### DRAWINGS

Certain examples will be described in relation to the drawings in which:

FIG. 1 is a perspective illustration of an example of a surface cleaning apparatus in an upright-in-use configuration;

FIG. 2a is a perspective illustration of the surface cleaning apparatus of FIG. 1 in a bent configuration;

FIG. 2b is a side view of the surface cleaning apparatus of FIG. 2a in a reciprocally advanced or extended position for cleaning under an obstacle;

FIG. 2c is a side view of the surface cleaning apparatus of FIG. 2b in a reciprocally retracted position;

FIG. 3 is a perspective illustration of the surface cleaning apparatus of FIG. 1 in a storage configuration;

FIG. 4 is an exploded view of a coupling assembly of the surface cleaning apparatus of FIG. 1;

FIG. 5 is a cross section taken along line 5-5 in FIG. 1;

FIG. 6 is a cross section taken along line 6-6 in FIG. 2;

FIG. 7 is a cross section taken along line 7-7 in FIG. 3;

FIG. 8 is a perspective illustration of an alternate example of a surface cleaning apparatus in an upright-in-use-configuration;

FIG. 9 is a cross section taken along line 9-9 in FIG. 8;

FIG. 10 is a cross section taken along line 9-9 in FIG. 8, showing the surface cleaning apparatus in a bent-in use configuration.

### DESCRIPTION OF VARIOUS EXAMPLES

Various apparatus or methods will be described below to provide an example of each claimed invention. No example described below limits any claimed invention and any claimed invention may cover processes or apparatus that are not described below. The claimed inventions are not limited to apparatus or processes having all of the features of any one apparatus or process described below or to features common to multiple or all of the apparatus described below. It is possible that an apparatus or process described below is not an embodiment of any claimed invention.

Examples disclosed herein provide a handle for a surface cleaning apparatus, such as a sweeper, which can be used in multiple configurations. For example, the handle can be configured in an upright in-use configuration, in which the surface cleaning apparatus may be used for normal surface cleaning operations, such as sweeping a floor. Alternatively the handle can be position in a bent configuration, such as may permit the cleaning apparatus to be used reach less accessible surfaces, such as when sweeping under furniture or the like. Further, the handle can be moved to a storage configuration, in which the handle is folded in half, such that the height of the apparatus is reduced, as for storage.

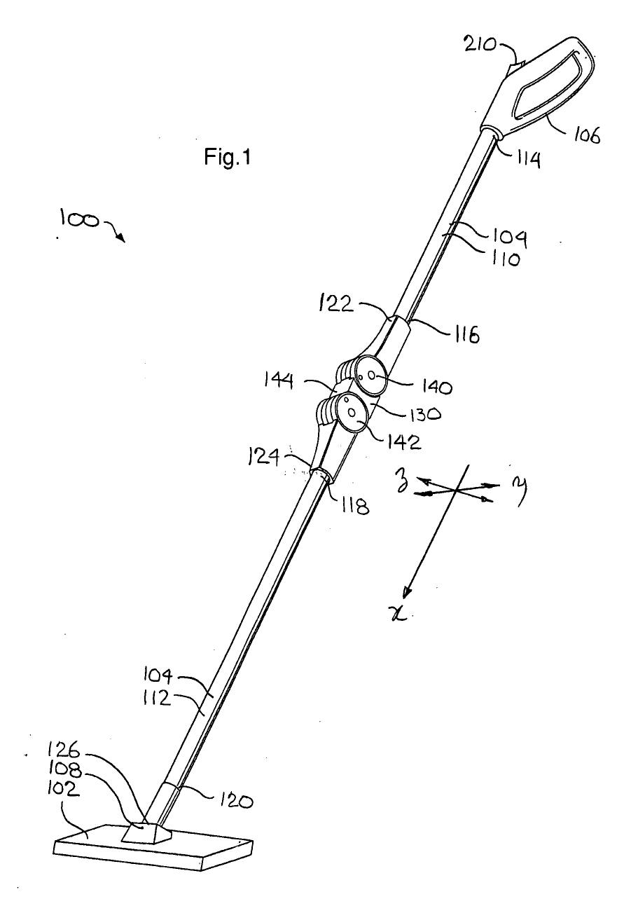

Referring to FIGS. 1 to 3, an example of a surface cleaning apparatus 100 is shown. Surface cleaning apparatus 100 has a surface cleaning head 102 and a handle assembly 104. In the example shown, surface cleaning apparatus 100 is a sweeper. Accordingly, surface cleaning head 102 is operable to sweep a surface and to collect dirt therefrom. In other examples, surface cleaning apparatus 100 may be a type of surface cleaning apparatus, such as a mop, a vacuum cleaner, a steamer, a carpet pick or other like device.

It may help to define a frame of reference with respect to the handles and handle components discussed herein. As shown in FIG. 1, handle assembly 104 has the orientation of a straight, or substantially straight, shaft. The shaft defines a lengthwise, or longitudinal, or axial direction that runs, or extends, from an hand grip 106 at which a user may grasp or manipulate the apparatus, to the cleaning head 102. The axial direction may also be notionally designated as the x-axis. Handle assembly 104 is joined, or operatively connected to, cleaning head 102 at a force transfer interface, or joint, indicated generally as 108. Force transfer interface 108 may have at least a first degree of freedom, that degree of freedom being a rotational degree of freedom permitting cleaning head to pivot about an axis normal to the axial direction of the handle assembly, notionally indicated as a y-axis. Quite typically the force transfer interface may have more than one degree of freedom, the second degree of freedom also being a rotational degree of freedom about a second axis perpendicular to the shaft, and commonly mutually perpendicular to the axis of the first degree of freedom. That second axis may be notionally identified as a z-axis. The end joint may be a universal joint, or a spherical ball joint providing both azimuth and horizontal rotational degrees of freedom. The terminology “proximate” and “distal” may take the hand grip 106 as their origin or point of reference, and points along the path of the handle assembly, whatever its configuration, may be seen in that light. The terms “upward” and “downward” and such like are at least to some extent arbitrary, since the cleaner may be used in the customary orientation working on flooring, or, perhaps less commonly, against walls, as may be.

In the example at hand, handle assembly 104 has a first, or upper portion 110, and a second, or lower portion 112. First portion 110 has a first, or upper, end 114 and a second, or lower, end 116. Similarly second portion 112 has a first or upper end 118 and a second, or lower, end 120. At first end 114 of first portion 110 there is a force transfer interface, which may be an input force transfer interface, and which may be identified as a hand grab, or handle, or hand grip 106. This force transfer interface, or grip, 106 is one at which a moment couple may be imparted to first handle portion 110. Second end 116 of first handle portion 110 is mechanically connected to first end 118 of second handle portion 112 at, or by, a force and motion transfer interface assembly or module indicated generally as intermediate connection 130. Second end 120 of second portion 112 is connected to cleaning head 102 as indicated above.

Intermediate connection 130 is a force and motion transmission assembly having an input interface 122, namely the fitting or connection at which it is connected to first handle portion 110, and an output interface 124, namely the fitting or connection at which it is connected to second, or lower, handle portion 112. Between input interface 122 and output interface 124 intermediate connection 130 has a first lockable joint 140 and a second lockable joint 142. In the embodiment shown first lockable joint 140 is arbitrarily identified as the proximal, or upper, lockable joint, and lockable joint 142 is likewise the distal, or lower, lockable joint located nearer to cleaning head 102.

In the example shown, lower end 120 of lower handle portion 112 is mounted to joint 126 of force transfer interface 108. Handle assembly 104 is usable to move surface cleaning head 102 along a surface, and is pivotally mounted to surface cleaning head 102 at joint 126. Joint 126 may be any pivoting joint known in the art. Joint 126 allows handle assembly 104 to pivot with respect to surface cleaning head 102 at least about a first axis, typically a cross-wise, or y-axis. In some embodiments joint 106 may also allow handle assembly 104 to pivot with respect to surface cleaning head 102 about the substantially vertical or z-axis, mutually perpendicular to the y-axis and the x-axis.

As noted hereinbelow, handle assembly 104 is movable such that surface cleaning apparatus 100 may be used in a plurality of configurations. For example, FIG. 1 shows handle 104 in an “upright” configuration in which handle assembly 104 is generally straight and surface cleaning apparatus 100 is usable, for example, for general cleaning. The term “upright” is a term of art. It implies the use of a substantially rigid handle assembly that is operated by a user in a standing position, the handle being held predominantly upwardly of the cleaning head. For a shorter person the angle will be shallower than for a taller person, and the angle may not be greater than 45 degrees, although it will most probably be greater than 30 degrees upward from horizontal. “Upright” implies operation in the manner of a mop, with the handle assembly functioning predominantly as a strut in compression or tension to push or pull the working head, e.g., cleaning head 102.

In this first, or locked, mode, intermediate connection 130 has no degree of freedom between input 122 and output 124. That is to say, in this first or locked mode both joints 140 and 142 are locked and intermediate connection 130 locks the position of portion 110 relative to portion 112, such that the entire assembly constitutes a rigid strut from the input interface at hand grip 102 to the output interface at cleaning head 102.

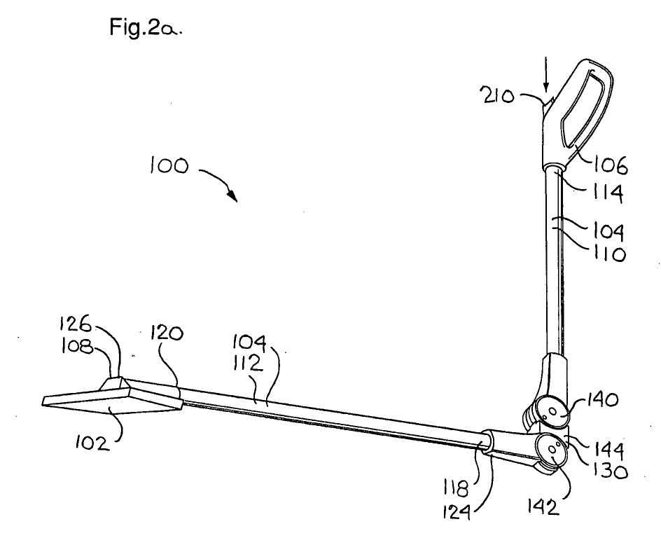

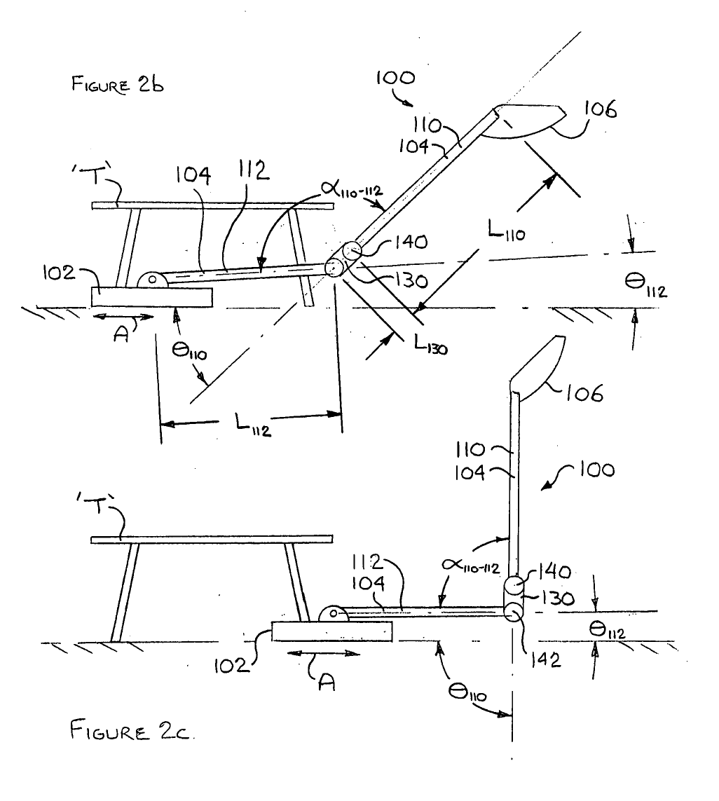

FIGS. 2a, 2b and 2c show handle assembly 104 in a bent configuration, in which lower joint A64 of handle assembly 104 is bent, such as may be usable, for example, for cleaning under furniture, or other places of lesser accessibility. In this second, or partially unlocked, mode intermediate connection, one of joints 140 or 142 has a single degree of freedom, that degree of freedom being a rotational degree of freedom. In this mode while the handle assembly is rigid in the y-direction, and is consequently capable of passing a bending moment about the z-direction across joint both upper and lower joints 140 and 142, and the knuckle 144 joining them, joint 142, being the lower joint, is not capable of passing a bending moment about the y-direction, and is capable of deflection about the y-axis. The physical significance of this may be understood by considering the prospect of passing the cleaning head under a coffee table or under a chair. Upper handle portion 110 may be held such that it extends downwardly from the user's hand at some level and angle. The level of cleaning head 102 will be dictated by the level of the surface to be cleaned, constraining motion of cleaning head 102 to a plane. First handle portion 110 has a length from grip to the center of rotation of the first joint of L₁₁₀. Second handle portion 112 has a length from the center of rotation of the second joint to the pivot connection to the cleaning head of L₁₁₂. The length of the link, or lug, of connection assembly 130 between the centers of rotation of joints 140 and 142 is identified as L₁₃₀. In the second mode of operation, the link (i.e., intermediate connection 130) is aligned with and fixed in a rigid position with respect to first handle portion 110, such that the length from the grip to the center of rotation of the second joint is merely the sum of L₁₁₀+L₁₃₀. Provided that grip 106 is held at a height that is suitably less than the sum of L₁₁₀+L₁₃₀+L₁₁₂ which is, of course, the total rigid length of handle assembly 104 in the first or locked mode, second handle portion 112 will find the appropriate angle of declination or dip, or azimuth angle, as it may be called. That is, its position is still uniquely determinate. To the extent that the interface at the cleaning head has azimuth and horizontal angular degrees of freedom, but not a torsional degree of freedom, a torsional twist of first handle portion 110 will still be transmitted to cleaning head 102, allowing it to be steered. Similarly, since lower joint 142 is rigid about the z-axis, the users can sweep cleaning head 102 sideways, i.e., circumferentially relative to grip 106.

Second joint 142 may have a range of motion in which it is substantially free to deflect from the rigid orientation. In one embodiment that angular range of motion may be from 0 degrees (i.e., the locked or straight orientation) to perhaps as much as about 90 to 120 degrees from straight. While the rigid orientation of first and second handle portions 110 and 112 may be in axial alignment, it need not necessarily be so, but could be a dog-leg or dihedral angle as may be. In any case, once unlocked, there may be a free range of motion. A rigid handle, or handle assembly may be problematic in terms of cleaning under a chair or table, for example, requiring the user to lower the handle nearer to floor level. This may necessitate bending of the back. By contrast, a jointed handle, as shown and described, can be operated with the second handle portion 112 at or near a condition parallel to the surface to be cleaned, be it a floor or carpet, or at a shallow angle [theta₁₁₂] with respect thereto (shallow being in the range of perhaps 0 to 30 degrees from horizontal) while the first, or upper portion of the handle 140 is operated in a much more steeply angled orientation [theta₁₁₀] in the range of 30 or 45 degrees from the horizontal to vertical or perhaps somewhat past vertical i.e., to the point at which the included angle [alpha₁₁₀₋₁₁₂] between first and second handle portions A30 and 110 is acute as in FIG. 2c, rather than obtuse as in FIG. 2b. Note that [alpha₁₁₀₋₁₁₂]+([theta₁₁₀]−[theta₁₁₂])=180. The user may then impart a motion having a significant or predominant component of rotation about the y-axis at grip 106, e.g., by flexing the wrist forward and backward, to produce something of a pivoting rotational motion of second joint 142, with second handle portion 110 functioning as a connecting rod between joint 142 and cleaning head 102. This may permit the user to use a pivoting wrist or short arm motion to cause the cleaner to reciprocate over the floor, as suggested by double headed arrow ‘A’, underneath obstructions such as chairs, beds and tables, symbolized in FIGS. 2b and 2c by table ‘T’, without necessarily unduly bending the user's back.

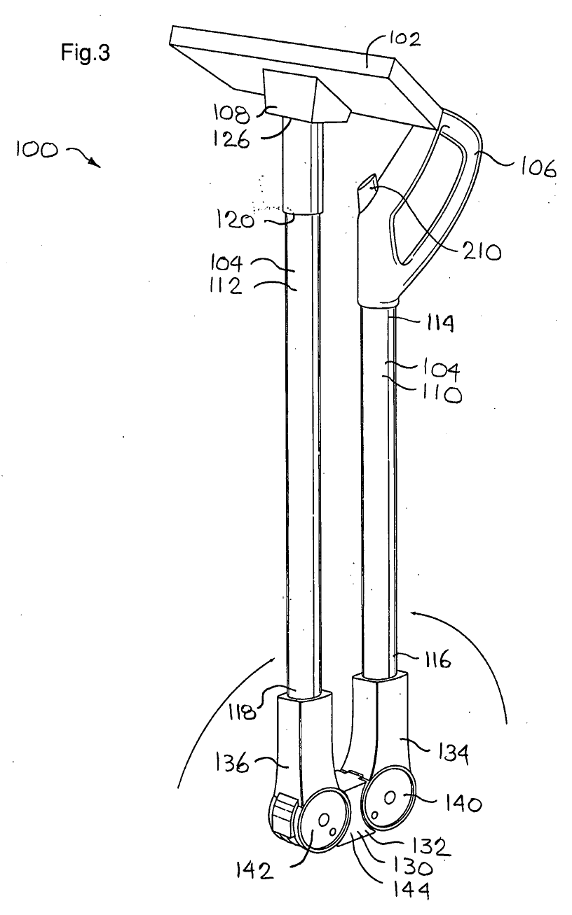

FIG. 3 shows handle assembly 104 in a storage configuration, in which handle assembly 104 is folded over such that surface cleaning apparatus 100 is more compact, as for storage or transport. At the end of the angular range of motion discussed above, further deflection of second joint 142, does not occur, because it has reached the end of the range of travel. On application of a greater torque, as by applying a greater bending moment about the y-axis at what would otherwise be the end of free travel range, deflection may then be caused in the other joint, namely first joint 140, permitting a third mode of deflection, namely that of FIG. 3 in which the leg is bent back upon itself, with a right angle bend in joint 140, and another right angle bend in joint 142 such that second portion 112 reverses, and lies beside first portion 110, and handle grip 106 is brought to a position generally near or adjacent to cleaning head 102. The resulting configuration may be considered a folded, storage or shipment configuration.

Referring still to FIGS. 1 to 3, handle assembly 104, as noted, has a first or upper handle portion 110 and a second or lower handle portion 112. Each of the first and second handle portions 112 and 114 is elongate. Portions 112 and 114 may be of similar length and shape. In alternate examples, portion 112 and portion 114 may be of different shapes and lengths. Upper portion 112 and lower portion 114 may be of suitable cross-section for transmitting a bending moment. Suitable second moments of area may be obtained for example with a channel or closed section, one such closed section being a hollow cylindrical tubular section. These components may be made of metal materials such as aluminum, steel, (which may be stainless steel) or plastics such as moulded plastic, which may be fibre reinforced composites. In one embodiment portions 110 and 112 may be hollow aluminum extrusions of constant cross-section. Portions 110 and 112 may be of the same, or substantially the same cross-section.

Lower handle portion 112 and upper handle portion 114 are pivotal with respect to each other to provide the plurality of configurations shown in FIGS. 1 to 3. In the example shown, lower handle portion 112 is pivotal about a first y-axis, namely that of joint 142, and upper handle portion 110 is pivotal about a second y-axis, namely that of joint 140, which is parallel to axis 101. For example, when handle 104 is in the upright-in-use configuration shown in FIG. 1, lower handle portion 112 and upper handle portion 110 may tend to be substantially co-axial, or parallel. For example, lower handle portion 112 and upper handle portion may be at a first angle (which may be expressed conveniently in degrees as 180−alpha₁₁₀₋₁₁₂) of about 0 to 15 degrees with respect to each other. In the example shown in FIG. 1, this angle is about 0 degrees.

When handle 104 is in the bent configuration shown in FIGS. 2a, 2b, and 2c lower handle portion 112 and upper handle portion 110 are at a second, different, angle with respect to each other. That angle (again, as 180−alpha₁₁₀₋₁₁₂) of about 15 degrees to about 105 or 120 degrees to each other. In the example shown it is 90 degrees. When handle 104 is in the storage configuration shown in FIG. 3, lower handle portion 112 and upper handle portion 110 are at a third, again different angle with respect to each other. That third angle may be at between about 105 or 120 degrees and about 180 degrees. In the example shown that angle is roughly 180 degrees.

In the example shown, intermediate connection 130 may have the form of a coupling assembly 128 provided to link upper and lower portions 110, 112 of handle assembly 104. Coupling assembly 128 includes first and second pivoting lockable joints 140, 142, and is mounted to upper end 118 of lower handle portion 112 and lower end 116 of upper handle portion 110. Accordingly, pivoting lockable joints 140, 142 are between handle portions 110 and 112, at a mid-region of handle assembly 104. Alternatively, one or both of first and second pivoting lockable joints 140, 142 may be integral with either lower handle portion 112 or upper handle portion 114. In such examples, the pivoting lockable joints may not be between lower handle portion 112 and upper handle portion 110.

First and second pivoting lockable joints 140, 142 each allow lower handle portion 112 and upper handle portion 110 to pivot with respect to each other, and further, are releasably lockable. That is, in the example shown, the lockable joints are lockable such that handle assembly 104 may be locked in the “upright”, or substantially straight, or rigid, configuration of FIG. 1. When second pivoting lockable joint 142 is unlocked, the handle assembly may be reconfigured into the bent configuration as shown in any of FIGS. 2a, 2b and 2c. When first pivoting lockable joint 140 is unlocked, the handle may be reconfigured into the fully folded storage or transport configuration.

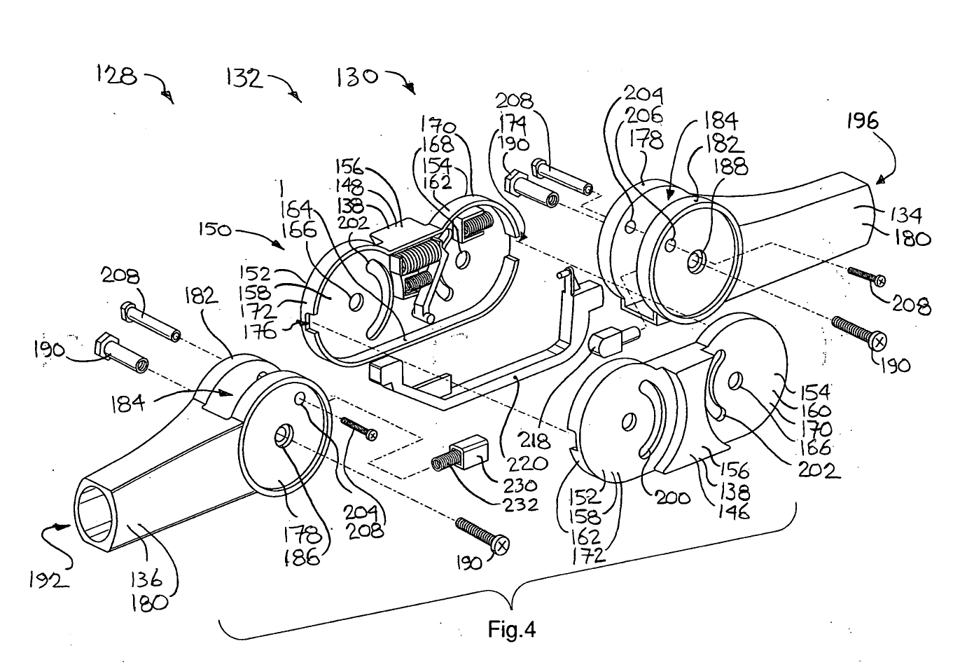

Referring now to FIG. 4, intermediate connection 130 may also be referred to as a coupling assembly 128. Coupling assembly 128 has a central assembly, or link, or lug, identified generally as central assembly 132, to which are mounted first and second connection members, or seats, or sockets, or fittings, or connection interface members, identified as upper and lower arms 134 and 136 respectively. Lower and upper arms 136 and 134 define the sockets or connections to which the respective mating ends of first and second handle portions 112 and 110 are mated. These connections are moment connections (i.e., both lateral shear loads and bending moments may be passed across the connections).

The frame, or skeleton, or shell, or casing of the connector link central assembly 132, identified as body 138, includes a pair of mating first and second back shell halves 146, 148 that, when mated together define an hollow internal cavity, indicated generally as 150. Back shell halves 146 and 148 each have first and second generally rounded end portions 152, 154 and an intermediate or interstitial portion 156 intermediate those end portions. Rounded end portions 152, 154 each have a generally circular flange or face 158, 160 extending in an x-z plane, and a depending peripheral curtain, or skirt, or wall 162 that has portions extending about the periphery of the circular faces, with that peripheral wall having a straight or tangential portion 164, such that the curtain wall runs along one edge from end to end. When the back shell halves 146, 148 are brought together the distal edges of the respective peripheral curtain walls 162 abut, leaving the hollow internal space, namely cavity 150, which, at the ends, extends between two parallel circular planar walls, 158, or 160, as may be. When mated together, the circular walls or faces 158, 160 have mutually aligned central bores 166, 168. The hollow circular end portions that result from the mating of the two backshell halves define lugs, or arms, or toes, or tongues that are identified as first and second wing members 170 and 172.

The resultant peripheral wall has communication sockets, ports, accommodations or apertures 174, 176 at respective opposite ends thereof, 174 being arbitrarily identified as the upper aperture, and 176 being arbitrarily identified as the lower aperture. The apertures shown are four sided rectangular openings. They could as easily be round, or half round, or any other suitable shape. The through thickness of the body is thickest over the central interstitial portions 156.

Upper and lower arms 134 and 136 each have the general form of a clevis. One end, be it a first end, of each of arms 134 and 136 is defined by a root or shank 180 that has a central bore 182 for receiving a respective end of one or the other of portions 110 and 112. Shank 180 terminates at a pair of substantially circular ears or circular walls 178, 182 that define the other end of arms 130 and 134, as may be. Those ears or flanges or walls 178, 182 are substantially planar in x-z planes, and are spaced apart in the y-direction, and have substantially circular, parallel planar surfaces that define between them a central rebate or accommodation, indicated generally as 184, into which may be located a corresponding one of the end portions 170 or 172 of central body assembly 132. That is, the second end of each of arms 134, 136 is bifurcated and receives a tongue, in the form of one of the rounded ends of the body 128 of the central link identified as wing members 170 and 172. Wing members 170 and 172 have respective bores 186, 188 that align on installation with bores 166, 168. A pin, or a pair of threaded mutually engagable hardware fittings, such as a close fitting Chicago screw and bolt, passes through bores 186, 166, 168 and 188 in the y-direction, and forms the axle of the joint.

In summary, lower arm 136 has a first end and a second end. The first end is mountable to the upper end 118 of the lower handle portion 112. The first end of the lower arm 130 has a blind bore, or accommodation, or socket 192 into which upper end 118 of lower handle portion 112 is received. The two parts then have the interfitting relationship of male and female members. The relationship may be reversed: it is arbitrary which of the two is the male member, and which the female member. Upper end 118 may be secured in socket 192 in any suitable manner, such as by the use of adhesives, mechanical connectors such as screws, or friction. In some examples, upper end 118 is removably received in socket 192. A releasable detent may be provided, as at 194. Similar to lower arm 136, upper arm 134 has a first end and a second end. In the example shown, the first end of upper arm 134 has a socket 196 into which lower end 116 of upper handle portion 110 is received. Lower end 116 may be secured in socket 196 in any suitable manner, such as by the use of adhesives, mechanical connectors such as screws, or friction. In some examples, lower end 116 is removably received in socket 196, and may include a releasable detent 194. The geometry of upper arm 134 and the geometric relationship of upper arm 134 to lower end 116 of upper handle portion 110, may be the same, or substantially the same, as that of lower arm 136 and its relationship to upper end 118 of lower handle portion 112.

Expressed slightly differently, the second or upper end of lower arm 136 is pivotally mounted to the central assembly 132 to form second pivoting lockable joint 142. The second end of lower arm 136 has first and second opposed circular flanges (i.e., walls 178, 182), and a gap, accommodation 184, therebetween. Central assembly 132 has a lower rounded end portion 172 defining a circular tongue received in accommodation 184. A pivot pin, namely bolt 190 is inserted through the opposed flanges and the tongue, and is secured in place. Accordingly, the first and second flanges pivot about the pivot pin to allow the lower handle portion 112 to pivot with respect to the central assembly 132.

The geometry thus described establishes the basic structure of pivoting joints 140 and 142. Those joints have additional operational features that define and limit their range of motion, their locking and unlocking, and the circumstances under which they operate. The substantially circular end portions of the backshell halves 146, 148 of the link of central assembly 132 have aligned, circumferentially extending apertures 200, 202 such as may be termed arcuate guide slots. Those guide slots may subtend an arc of up to about 120 degrees, and, in one embodiment may be about 90 degrees. The clevis fingers, namely wing members 170, 172, have bores 204, 206 radially distant from bores 178, 182 that are positioned to co-operate with apertures 200, 202. On assembly, an indexing member, or guide pin, stop or dog 208 is fed through the aligned apertures and bores 204, 200, 202 and 206. Dogs 208 may have the form of another Chicago screw and bolt set. The angular range of motion of the joint, be it 140 or 142, will be bounded when the dogs 208 bottom out against (i.e., abut) the ends of the arcs of the circumferentially extending slots. The relationship is arbitrary and can be reversed such that the circumferentially extending guide slots are in wing members 170, 172, rather than in the tongue, or both wings and tongues can have slots, whose combined length provides the desired range of travel. In the embodiment illustrated, the range of travel of each of the joints may be approximately 90 degrees, or perhaps somewhat more, such as about 105 or about 120 degrees. Although the joints have substantially equal angular ranges of travel this need not necessarily be so. Nor, for that matter, does either range need to be 90 degrees. It may be that the sum of the ranges of travel is about 180 degrees, whether the ranges are equal or not.

Handle assembly 104 also has a signaling system or rig, or rigging, or an unlocking transmission, by which a user can send a signal, and motive power, to the locking members of central assembly 132. Recalling that the shaft of upper handle portion 110 is hollow, upper handle portion 110 may have an actuator 210, which may have the form of a trigger or a push button or other like member that may be operated by a person grasping hand grip 106. Actuator 210 may be operatively connected to a signal transmission member 212, which may be in the form of a connecting rod, or push rod 214 or even a pre-tensioned internal cable system (not shown). The distal end of push rod 214 (or such other device as may be) may pass through a locating fitting, such as a centering fitting 216, which may also serve as an end closure fitting of upper handle portion 110, and may protrude therefrom to engage a knob, a gubbins, a nipple, a finger, or such other name for a signal transmission output fitting or member, such as may be identified as a plunger fitting 218 that seats in, and is reciprocable in the axial direction within, a downwardly opening inner socket 219 defined at the base of shank 180 of upper arm 134.

Central assembly 132 also has an internal signal transmission member 220, which may have the form of a push rod 222. Push rod 222 may not be straight, but rather may be deviated, or have an intermediate deviation 224 between a first end member or first end lug or input signal receiving member which may have the form of a lug or tooth 226, and a second end member, or second end lug, or output signal transmitting member which, again, may have the form of a tooth 228. Finally, output arm 136 may have located centrally in the root thereof a detent member 230 mounted for axial reciprocation in an internal, upwardly opening socket 231. Detent member 230 is biased in the axial, nominally upward, direction (i.e., toward hand grip 106 when handle assembly 104 is in its straight orientation) by a biasing member in the nature of a spring 232. Aperture 176 has a short inward socket 234 that is of substantially the same width as detent member 230, and the has a somewhat narrower internal aperture 236 of a width to act as an eye or guide 238 for the second tooth, namely output signal transmission member 228. A shoulder 240 formed at the end of socket 234 defines a travel limiting stop against which detent member 230 may bottom. Input lug, namely member 226 fits closely in an axial sliding relationship within aperture 174. Push rod 222 may have a return spring seat 242, which may be in the form or a protruding flat or wing 244 that extends from push rod 222. A return spring 246 may be mounted in a socket or seat 248 fixed to one or other of backshell halves 146, 148, and is oriented to bear against seat 242. Push rod 222 may also have a forward travel limiter, or abutment, or stop, identified in the illustrations as a shoulder 250, that meets, or encounters, or engages, the back side or shoulder of socket 234 when push rod 222 is advanced sufficiently.

Connecting rod 220 also has a cam, or carrier arm, or dog, or abutment, or stop 252, that is positioned to interfere with travel of dog 208 in the clockwise direction in circumferentially extending aperture 202 of second wing member 172. When connecting rod 220 is advanced, and dog 208 of lower end 172 travels along aperture 202, it will, at the end of stroke when lower arm 236 (and hence lower handle portion 112) is at its fully deflected end of the range of motion, oppose the axially rearwardly facing surface or wall of stop 252, and urge, or hold, connecting rod 220 in its advanced position, overcoming such urgings of return spring 246 as may otherwise tend to cause first tooth 226 to wish to engage, or re-engage, or remain in, socket 198, and that would then otherwise preventing upper arm 134 from moving.

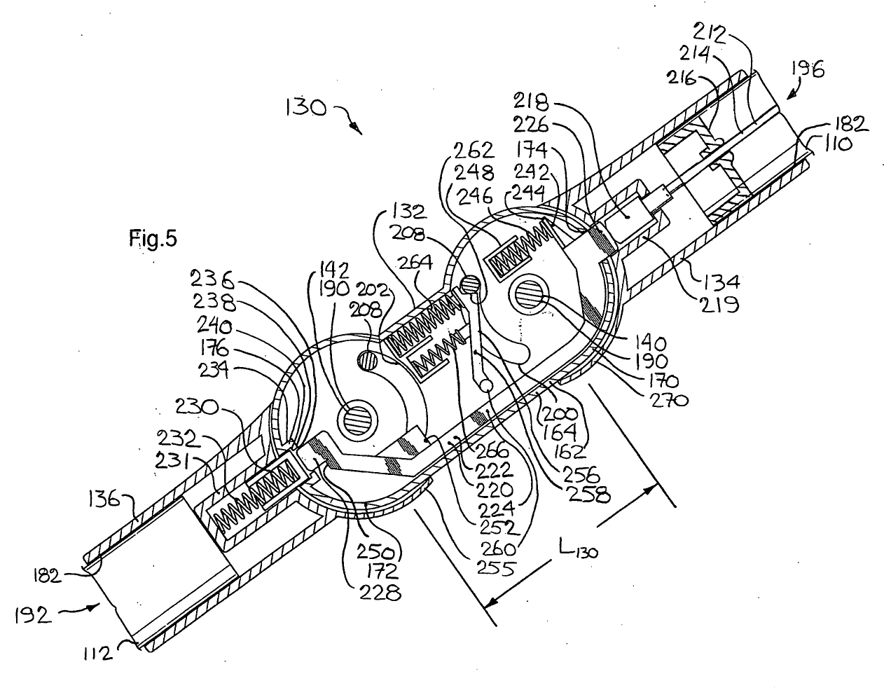

Referring to FIGS. 5 to 7, to the extent that central assembly 132 has a first lock defined by the interaction of upper tooth 226 with socket 198, and a second lock defined by the interaction of detent 230 with lower aperture 176, there is also a third locking mechanism, generally indicated as 254. There is a pivot arm 258 mounted within central assembly 132. Pivotal arm 258 has a first end having an axle, or trunnion whose nubs locate in opposed blind bores the opposite backshell halves, such that arm 258 can pivot about a pivot point 230. Pivot arm 258 has an abutment face or edge 262. First and second biasing members, identified as springs 264, 266 are mounted in corresponding seats mounted to backshell half 146 or 148, as may be, which urge pivot arm 258 to move clockwise, as viewed in FIG. 5. This motion is obstructed by a guide pin, namely dog 208 of end portion 170, such that dog 208 is trapped in the notch formed by abutment edge and the lip of arm 254 that extends across spring 264. This tends to keep dog 208 captured at the most clockwise end of circumferentially extending aperture 200. Accordingly, when actuator 210 is activated, and force (or a moment couple, really) is applied to move upper handle portion 110 with respect to lower handle portion 112, abutment edge 232 opposes the force, and prevents rotation of the upper arm 134 with respect to the central assembly 132. Accordingly, any moment applied between lower handle portion 112 and upper handle portion 110 will result in pivoting motion of lower lockable joint 142 as the path of least resistance.

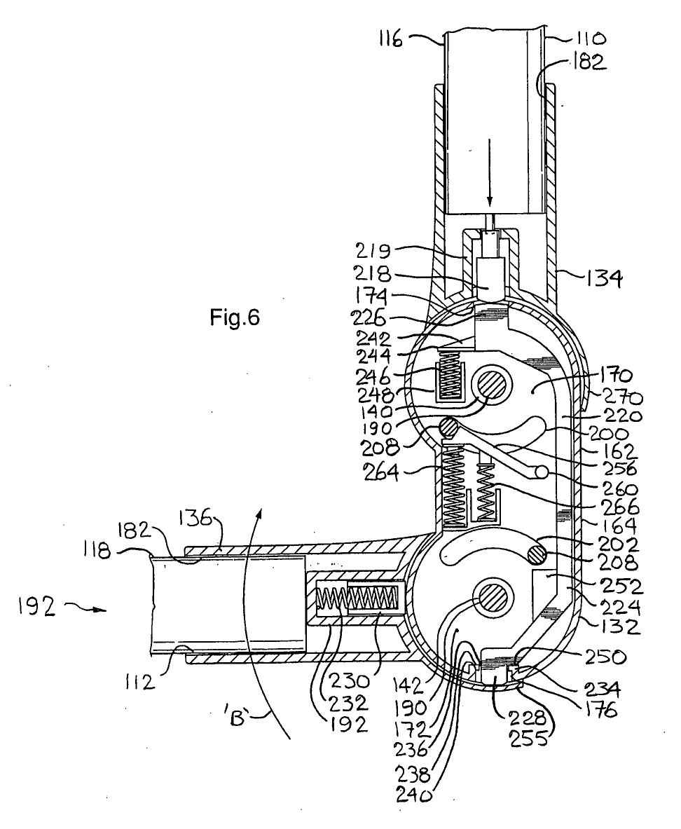

When lower arm 136 has pivoted to its full extent, for example by 90 degrees as shown in FIG. 6, such that dog 208 of end portion 172 meets the most clockwise, second, end of the guide slot, aperture 202, (and dog 208 bears against abutment 252, causing shoulder 250 to be held in its full travel, bottomed position against the back of socket 234), any additional force or moment applied between lower handle portion 112 and upper handle portion 110 will cause the second guide pin, namely dog 208 of end portion 170 to push against abutment edge 262. When enough force is applied to overcome the biasing force of springs 264, 266, pivot arm 258 will move counter-clockwise as viewed in FIG. 5, permitting dog 208 to move past the abutment edge 232 towards the most counter-clockwise, second end of the guide slot, aperture 200, allowing upper arm 134 to pivot counter-clockwise about pivot pin 190 and thus to permit upper handle portion 110 to move to the storage or transport configuration. Counter-clockwise motion is prevented both by dog 208 and by an external abutment in the nature of skirt extension 270 of upper arm 234. Accordingly, the third lock is unlocked by the application of force, and the second pivoting lockable joint is unlocked both by activating actuator 210 and by applying adequate force (or moment, really) to; the second pivoting lockable joint 142.

Arm 258 has a cam 256, which may extend into slot 200 when clockwise motion of arm 258 is not obstructed by the presence of dog 208. When handle assembly 104 is returned from the storage configuration of FIG. 3 to either the bent configuration of FIGS. 2a, 2b or 2c, or to the initial, straight configuration of FIG. 1, actuator 210 need not be activated, as neither tooth 226 nor tooth 228 is engaged when the joints are deflected. On return, dog 208 runs along the more gently oblique back of cam 256, and, in due course, snaps back into its initial position, and locks, as joint 140 is straightened second pin 214 is held in the unlocked position by cam 238 when the handle is in the bent-in-use configuration.

In the position illustrated in FIGS. 1 and 5, tooth 226 is in its initial or first or home position protruding through aperture 174 and into socket 196, thereby locking upper handle portion 110 and the link, connector assembly 130, in a fixed angular orientation to each other, notionally straight. In this condition, upper joint 140 cannot pivot. At the same time detent member 230 protrudes into socket 234, thereby locking lower handle portion 112 in position relative to central portion A130. In this condition, lower joint 142 also cannot pivot.

Forward motion of actuator 210 may then tend to urge push rod 214 forward, which may urge fitting 218 forward to work against the signal receiving member, i.e., tooth 226, of push rod 222 of transmission member 220. In so doing, the resistance of return spring 244 is overcome, and member 226 moves from its initial or first position protruding through aperture 174 to a less protruding position. As this occurs, the output lug, tooth 228, bears against detent member 230, overcomes the resistant of spring 232, and urges member 230 axially downward, clear of socket 234. This motion ends when shoulder 250 of pushrod 222 bottoms out, and the release assembly reaches the end of travel condition. At this point detent member 230 has been forced to a sufficiently retracted position that it is clear of socket 192, and arm 136 is able to pivot in the clockwise direction of Arrow ‘B’ (as shown in FIG. 5) about the center of rotation defined by pin 190. Both dog 208 and a skirt or housing extension 255 prevent motion in the counter-clockwise direction from the initial position shown in FIG. 5.

To recap, the first end, i.e., the clevis, of upper arm 134 is pivotally mounted to central assembly 132 to form the first pivoting lockable joint 140. In the example shown, the second end of the upper arm 134 has first and second opposed circular flanges, namely clevis wings 178, 182, and a gap, namely accommodation 184, therebetween. Central assembly 132 has an upper portion defining a circular tongue, or end, 170, that is received in accommodation 184. A pivot pin 190 is inserted through the first and second opposed flanges and the tongue. Accordingly, the first and second flanges pivot about the pivot pin 190 to allow the upper handle portion 110 to pivot with respect to the lower handle portion 112.

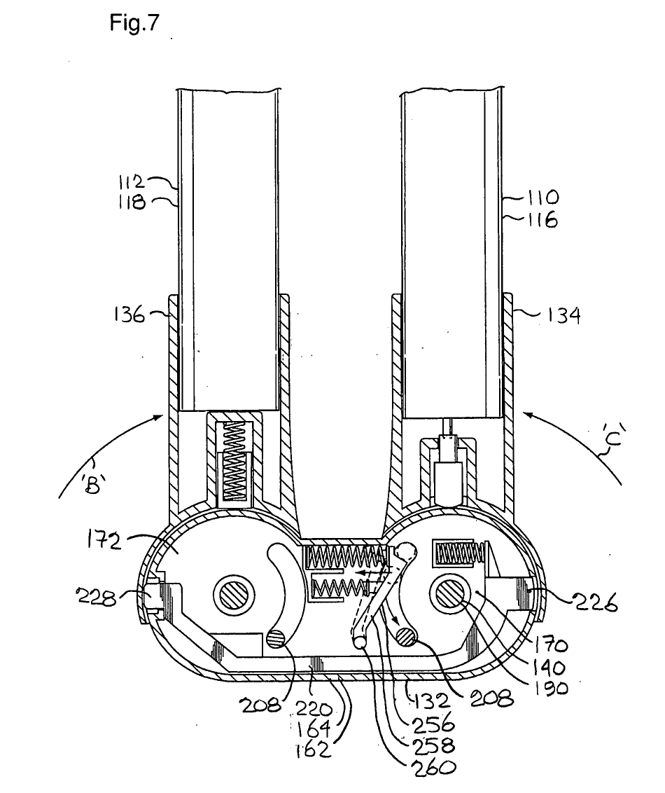

Similarly to the upper end or tongue, 170, the lower end 172 has a guide slot defined by co-operating apertures 200, 202, which defines an arc. That arc may extend for about 90 degrees. A guide pin 190 is inserted through the first and second opposed circular flanges, and is seated in the guide slot defined by apertures 202, 200. The guide slot and the guide pin limit the range of motion of the second pivoting lockable joint 126. That is, referring to FIGS. 5 and 6, when the handle is in the upright-in-use configuration and the bent-in-use configuration, the guide pin 186 abuts a first end 188 of the guide slot 184. Accordingly, the lower arm 130 may only pivot in a direction indicated by arrow A2. Referring to FIG. 7, when the upper arm 134 has been pivoted in the direction indicated by arrow A2 by 90 degrees, the guide pin 184 will abut a second end 190 of the guide slot 184, to thereby prevent any further pivoting.

In the example shown, as each of the guide slots extends for about 90 degrees, the combined total range of motion provided by the first and second pivoting lockable joints is about 180 degrees. However, in alternate examples, guide slots may not be provided, and the range of motion of the first and second pivoting lockable joints may not be limited, or may be limited to other, different, ranges of motion.

As noted, first and second pivoting lockable joints 140, 142 are releasably lockable. Referring to FIGS. 5 and 6, the second pivoting lockable joint 142 is lockable by a first lock. The first lock is defined by the relationship of a first aperture 176 defined in walls 162 of backshell halves 146, 148 of central assembly 132, and a second aperture defined by the mouth of socket 231 in the lower arm 130, and the plunger, or detent, or pawl, or tooth, or, in effect, lock bolt that is represented by detent 230. When the handle is in the upright configuration and the lower handle portion 112 and the upper handle portion 110 are generally axially aligned, these apertures are aligned, as shown in FIG. 5, and detent 230 is biased to extend across the small gap between them, and to lock them against relative motion, just like a bolt driven home in a lock. Spring 232 provides the biasing force. Thus the pin, i.e., detent 230, locks the second pivoting lockable joint 142, and prevents the lower handle portion 112 from pivoting with respect to the central assembly 132. To unlock the first lock, a movable member is provided, namely tooth 228. It is biased in a first position, shown in FIG. 5, and is movable between that first position and a second position, shown in FIG. 6. When the first movable member, tooth 228, is moved to the second position it engages, i.e., contacts, the first pin, i.e., detent, 230, and pushes it in opposition to the biasing force of spring 232, thereby sliding the first pin out of aperture 176, and removed, unlocking the first or lower lock.

The first or upper pivoting lockable joint 140 is lockable by a second lock and by a third lock. The second lock is defined by a third aperture, namely aperture 174 in the flange or wall 162 of the back shell halves of central assembly 132, by a fourth aperture, namely the mouth of socket 219 defined in the upper arm 134, and tooth 226 which, like detent 230, whether termed a pin, pawl, stop, abutment, or any other like name, functions not only as the signal and force transmitting device, but also as the slidable bolt in the lock. When handle assembly 104 is in the upright configuration and the upper handle portion 110 and lower handle portion 112 are generally axially aligned, or when handle assembly 104 is in the bent configuration and lower handle portion 112 has been pivoted with respect central assembly 132, these apertures are aligned, as shown in FIGS. 5 and 6. Spring 246 provides the biasing force tending to push tooth 226 to the engage position in which the bolt of the lock is driven home. Accordingly, when handle assembly 104 is in the upright configuration handle portions 112 and 114 are generally axially aligned, the second pin, tooth 226, locks the first or upper pivoting lockable joint 140, and prevents upper handle portion 110 from pivoting with respect to the central assembly 132. Another movable member, plunger 218 is driven to unlock the first or upper lock. The second movable member, plunger 218, is biased in a first position, shown in FIG. 5, and is movable between the first position and a second position, shown in FIG. 7. When this movable member is moved to its second position, it engages, i.e., contacts, the pin, i.e., tooth 218, and drives it out of the fourth aperture, unlocking that lock and permitting rotational movement of joint 140.

To move both first movable member, tooth 226, and second movable member, tooth 228, handle assembly has a control, namely actuator 210 (FIGS. 1-3). It has a button located amidst on handgrip 106. The button is biased in a non-pushed configuration, and is movable between the non-pushed configuration and a pushed configuration. The biasing force may be provided, for example, by a spring, such as springs 248 and 242, or some other spring (not shown). The button is drivingly connected to a drive train that may include rod 212, that extends through upper handle portion 110, between the button and the second removable member, tooth 226. When the button is pushed, the rod pushes the second movable member from the first position to the second position, and the second movable member pushes the second pin out of the fourth aperture to unlock the second lock. Further, when the second movable member pushes on the second pin, the first movable member moves together with the second pin, and pushes the first pin out of aperture 176. Accordingly, in the example shown, when the control is activated, the first lock and the second lock are simultaneously unlocked.

As noted the second pivoting lockable joint is lockable by the second lock and by a third lock. The third lock is not unlocked by actuator 210. Accordingly, when actuator 210 is moved, the first and second locks are unlocked, but the third lock remains locked. As such, when the control is actuated, the second pivoting locking joint 142 is unlocked, and lower arm 136 may pivot with respect to the central assembly 132, but the first pivoting locking joint 140 remains locked, and the upper arm 134 may not pivot with respect to the central assembly 134.

To reconfigure the handle from the storage configuration of FIG. 3 back to the bent configuration of FIGS. 2a, 2b and 2c, or the upright configuration of FIG. 1, force may be applied to pivot the upper handle portion 110 and lower handle portion 112 away from each other. When enough force is applied to the upper handle portion 110, guide pin 208 will ride against pivotal arm 258 such that it pivots away, and the guide pin, dog 208, will snap back into place between the abutment edge 262 and the second end of the guide slot to lock the third lock. Further, when the upper arm portion 110 and the lower arm portion 112 are pivoted back to the upright configuration, detent 230 will snap back into aperture 176, and tooth 226 will snap back into the fourth aperture defined by the mouth of socket 219, to re-lock the first and second locks.

Accordingly, a user may use surface cleaning apparatus 100 in the upright configuration. If the user desires to clean a hard to reach surface, for example a surface under a piece of furniture (e.g., Table ‘T’), the user may actuate the control and apply force to pivot lower handle portion about lower joint 142 of central assembly 132 and convert surface cleaning apparatus 100 to the bent configuration. In order to revert back to the upright configuration, the user may apply force to pivot lower handle portion 112 backwards until the lock snaps back into a locked configuration. To convert the surface cleaning apparatus to a storage configuration, the user may convert the surface cleaning apparatus to the bent configuration, and then may apply force to unlock the third lock, and pivot the upper handle portion 114 towards the lower handle portion 112, the moment couple required to pivot second joint 142 being less than the moment couple required to overcome the resistance to displacement of the third lock inhibiting motion of first joint 140.

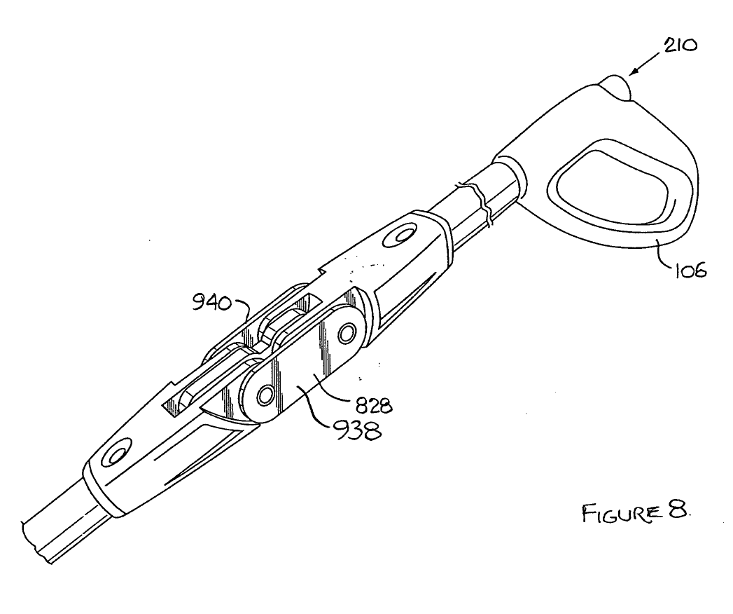

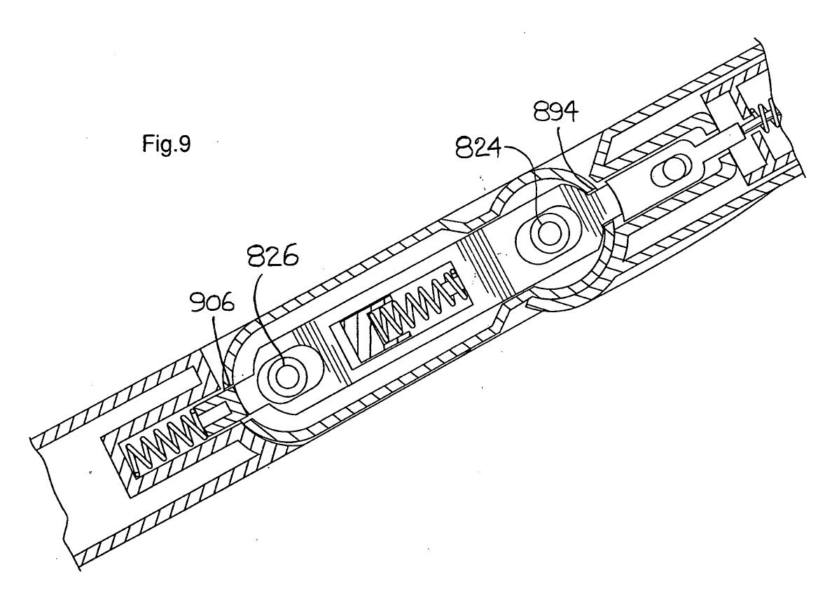

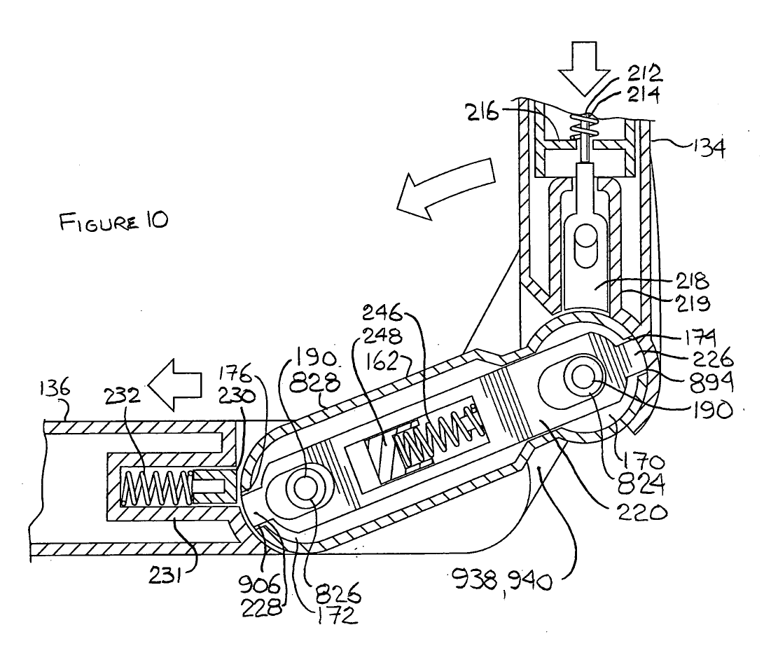

An alternate example of a coupling assembly 828 is shown in FIGS. 8 to 10. In this example, coupling assembly 828 has only a first lock 894 and a second lock 906. Accordingly, when the control is actuated, both the first lock 894 and the second lock 906 are unlocked, and the first pivoting lockable joint 824 and the second pivoting lockable joint 826 are unlocked. Further, in this example, guide slots and guide pins are not provided. Further, in this example, opposed side arms 938, 940, are provided, which provide support to the first 824 and second 826 joints.

In alternate examples (not shown), a control may be provided which unlocks only one lock of handle 104, such that only one of the first pivoting lockable joint 124 and the second pivoting lockable joint 126 is unlocked when the control is actuated. Accordingly, a second control may be provided which unlocks a second lock, and optionally, a third control may be provided which unlocks a third lock.

It will be appreciated that while the design has been exemplified by a handle that does not have air flow therethrough, the design may be adapted to a handle or wand that has air flowing therethrough either by using a rotatable air flow coupling, such as disclosed in U.S. Pat. No. 6,695,352 or a flexible hose as disclosed in U.S. Ser. No. 12/010,358 the disclosure of each of which is incorporated herein by reference. It will be appreciated that, in such designs, the pivot joint and the lock for the pivot joint are preferably located exterior to the air flow passage as exemplified in U.S. Ser. No. 12/010,358.

1. A handle for a surface cleaning apparatus comprising
a) a lower handle portion;
b) an upper handle portion;
c) a first pivoting lockable joint provided between the lower handle portion and the upper handle portion; and
d) a second pivoting lockable joint provided between the lower handle portion and the upper handle portion.

2. The handle of claim 1, further comprising a coupling assembly mounted to the lower handle portion and the upper handle portion, wherein the coupling assembly comprises the first pivoting lockable joint and the second pivoting lockable joint.

3. The handle of claim 2, wherein the coupling assembly comprises:
a) a central assembly comprising a lower member portion and an upper member portion;
b) a lower arm having a lower arm first end mounted to the lower handle portion and a lower arm second end pivotally mounted to the lower member portion; and
c) an upper arm having an upper arm first end mounted to the upper handle portion and an upper arm second end pivotally mounted to the upper member portion;
wherein the lower member portion and the lower arm second end define the first pivoting lockable joint; and
the upper member portion and the upper arm second end define the second pivoting lockable joint.

4. The handle of claim 3, wherein the first pivoting lockable joint is lockable by a first lock, the first lock comprising:
a) a first aperture in the lower member portion;
b) a second aperture in the lower arm; and
c) a first pin biased to sit in extend between the first aperture and the second aperture to prevent rotation of the lower arm about the central assembly.

5. The handle of claim 4, wherein the first lock is unlocked by sliding the first pin out of the first aperture and into second aperture.

6. The handle of claim 5, wherein the second pivoting lockable joint is lockable by a second lock, the second lock comprising:
a) a third aperture in the upper member portion;
b) a fourth aperture in the lower arm; and
c) a second pin positionable to sit in and extend between the third aperture and the fourth aperture to prevent rotation of the upper arm about the central assembly.

7. The handle of claim 6, wherein the second lock is unlocked by sliding the first pin out of one of the third aperture and the fourth aperture and into the other of the third aperture and the fourth aperture.

8. The handle of claim any of claim 7, wherein the second pivoting lockable joint is further lockable by a third lock, the third lock comprising
a) a guide pin mounted to the upper arm; and
b) an abutment edge in the central assembly and biased against the guide pin to prevent rotation of the upper arm about the central assembly.

9. The handle of claim 8, further comprising a control configured to simultaneously unlock the first lock and the second lock when actuated, wherein the third lock is unlocked by the application of force to the third lock.

10. The handle of claim 1, wherein the first pivoting lockable joint and the second pivoting lockable joint each comprise a first lock, and the handle further comprises a control configured to simultaneously unlock each of the first locks when actuated.

11. The handle of claim 10, wherein one of the first pivoting lockable joint and the second pivoting lockable joint comprises a second lock, wherein the second lock is unlocked at least by the application of force.

12. The handle of claim 1, further comprising a control configured to unlock one of the first pivoting lockable joint and the second pivoting lockable joint when actuated.

13. The handle of claim 12, wherein the other of the first pivoting lockable joint and the second pivoting lockable joint is unlocked at least by the application of force.

14. The handle of claim 9, wherein:
a) a handgrip is mounted to the upper handle portion; and
b) the control is provided on the handgrip.

15. The handle of claim 1, wherein:
a) the first pivoting lockable joint allows the handle to be reconfigured from an upright-in-use configuration to a bent-in-use configuration; and
b) the second pivoting lockable joint allows the handle to be reconfigured from the bent-in-use configuration to a storage configuration.

16. The handle of claim 1, wherein the first pivoting lockable joint is provided adjacent the lower handle portion, and the second pivoting lockable joint is provided adjacent the upper handle portion.

17. The handle of claim 1, wherein the first pivoting lockable joint and the second pivoting lockable joint provide a 180 degree range of movement between the lower handle portion and the upper handle portion.

18. The handle of claim 1, wherein the lower handle portion and the upper handle portion are pivotal about parallel axes.

19. A handle for a surface cleaning apparatus comprising
a) a lower handle portion at a lower region of the handle;
b) an upper handle portion at an upper region of the handle;
c) a first pivoting lockable joint at a mid-region of the handle; and
d) a second pivoting lockable joint at the mid-region of the handle.

20. The handle of claim 19, further comprising a control configured to unlock one of the first pivoting lockable joint and the second pivoting lockable joint when actuated, wherein the other of the first pivoting lockable joint and the second pivoting lockable joint is unlocked at least by the application of force.

21. The handle of claim 19, wherein:
a) the first pivoting lockable joint allows the handle to be reconfigured from an upright-in-use configuration to a bent-in-use configuration; and
b) the second pivoting lockable joint allows the handle to be reconfigured from the bent-in-use configuration to a storage configuration.

22. The handle of claim 19, wherein first pivoting lockable joint and the second pivoting lockable joint provide a 180 degree range of movement between the lower handle portion and the upper handle portion.

23. The handle of claim 19 wherein the upper handle portion and lower handle portion are pivotal about parallel axes.

24. A handle for a surface cleaning apparatus comprising
a) a lower handle portion;
b) an upper handle portion;
c) a first pivoting lockable joint allowing the lower handle portion and the upper handle portion to pivot with respect to each other; and
d) a second pivoting lockable joint allowing the lower handle portion and the upper handle portion to pivot with respect to each other.

25. The handle of claim 24, further comprising a control configured to unlock one of the first pivoting lockable joint and the second pivoting lockable joint when actuated, wherein the other of the first pivoting lockable joint and the second pivoting lockable joint is unlocked at least by the application of force.

26. The handle of claim 24, wherein:
a) the first pivoting lockable joint allows the handle to be reconfigured from an upright-in-use configuration to a bent-in-use configuration; and
b) the second pivoting lockable joint allows the handle to be reconfigured from the bent-in-use configuration to a storage configuration.

27. The handle of claim 24, wherein first pivoting lockable joint and the second pivoting lockable joint provide a 180 degree range of movement between the lower handle portion and the upper handle portion.

28. The handle of claim 24 wherein the upper handle portion and the lower handle portion are pivotal about parallel axes.

29. A surface cleaning apparatus comprising:
a) a surface cleaning head;
b) a lower handle portion having a lower handle portion first end and a longitudinally opposed lower handle portion second end, the lower handle portion first end pivotally mounted to the surface cleaning head;
c) an upper handle portion having an upper handle portion first end and a longitudinally opposed upper handle portion second end;
d) a first pivoting lockable joint provided between the lower handle portion second end and the upper handle portion first end; and
e) a second pivoting lockable joint provided between the lower handle portion second end and the upper handle portion first end.
